(19) United States
(12) Patent Application Publication
(10) Pub. No.: US 2013/0092663 A1
(43) Pub. Date: Apr. 18, 2013

(54) METHOD OF PREDICTING SPOT WELD FAILURE

(71) Applicants: Yung-Li Lee, Troy, MI (US); Santosh Balur, Auburn Hills, MI (US)

(72) Inventors: Yung-Li Lee, Troy, MI (US); Santosh Balur, Auburn Hills, MI (US)

(21) Appl. No.: 13/334,701

(22) Filed: Dec. 22, 2011

Related U.S. Application Data
(63) Continuation-in-part of application No. 13/273,536, filed on Oct. 14, 2011, now abandoned.

(51) Int. Cl. B23K 11/11

(52) U.S. Cl. 219/91.2

(57) ABSTRACT

A method is provided and may include generating by a computer a virtual vehicle model and providing the vehicle model with spot-welds. The method may further include providing data regarding the spot-welds and applying forces by the computer to the spot welds during a simulated impact event of the vehicle model. The computer may analyze each of the spot welds at predetermined time intervals during the simulated impact event and may identify failed spot welds based on the analyzing. The computer may further remove failed spot welds from the vehicle model and may continue to apply the forces to the spot-welds following removal of the failed spot welds.

### CROSS-REFERENCE TO RELATED APPLICATIONS

This application is a continuation-in-part of U.S. patent application Ser. No. 13/273,536 filed on Oct. 14, 2011. The entire disclosure of the above application is incorporated herein by reference.

### FIELD

The present invention relates to a method of analyzing spot welds and more particularly to a method of predicting spot weld failure.

### BACKGROUND

Vehicle design plays a role in determining how a vehicle will perform during an impact event. Namely, the size, shape, and weight of the vehicle—just to name a few—affect the overall performance of the vehicle during an impact event. Further, performance of a particular vehicle during an impact event can be varied as parameters of the impact event are varied. For example, altering the speed and/or physical barrier (i.e., reinforced wall versus offset, honeycomb structure) likewise affects the performance of the vehicle.

Providing an engineer with information relating to how a vehicle may perform during an impact event in the early stages of vehicle development provides information that may be used to alter the design of the vehicle and, thus, its performance during an impact event. While such information is valuable during the early stages of vehicle development, such information is typically unavailable, as physical vehicles are not available for testing. To that end, vehicle manufacturers typically utilize vehicle crash simulation software and other virtual crash simulation devices in an effort to determine how a particular vehicle will perform when subjected to various forces associated with an impact event. Performing simulated impact events may be used during the early stages of vehicle development to aid engineers in designing a vehicle and may be used throughout the vehicle development process to minimize the number of actual vehicle impact tests. Reducing the number of actual vehicle tests reduces the cost associated with vehicle development and expedites the overall vehicle-development process.

Conventional virtual tools that perform vehicle crash simulation typically require numerous inputs to properly correlate a simulated vehicle impact event with actual test data. Such impact simulations work well when test data from actual vehicle tests is available, as correlation between the simulation and the actual tests can be easily performed. For example, conventional virtual tools assume that spot welds of a virtual vehicle model do not fail when performing a simulation. This assumption works well when actual vehicle test data can be used to correlate the results of the vehicle simulation.

While virtual tools are mostly reliable, such tools are less reliable when actual vehicle test data is not available. For example, vehicle impact simulations cannot be verified when performed during the early stages of vehicle development, as actual test data is typically not available for correlation with the simulation. When actual test data is not available for correlation with a simulation, assumptions—such as the assumption with respect to failure of simulated spot welds—may result in an erroneous result. Further, requiring such test data for correlation with a simulated impact event results in conventional virtual tools being complex, costly, and difficult to use.

### SUMMARY

A method is provided and may include generating by a computer a virtual vehicle model and providing the vehicle model with spot-welds. The method may further include providing data regarding the spot-welds and applying forces by the computer to the spot welds during a simulated impact event of the vehicle model. The computer may analyze each of the spot welds at predetermined time intervals during the simulated impact event and may identify failed spot welds based on the analyzing. The computer may further remove failed spot welds from the vehicle model and may continue to apply the forces to the spot-welds following removal of the failed spot welds.

A method may further include generating by a computer a virtual vehicle model and providing the vehicle model with spot-welds. The computer may determine the nominal shear stress (Sₛ) at a given load for each of the spot-welds by dividing the applied normal shear load by the product of the weld diameter and the thickness of the smallest sheet meal used in forming the spot weld and may determine the ultimate dynamic shear strength (S_{s,dynamic}) of each of the spot welds. A first ratio may be determined by dividing the nominal shear stress (Sₛ) by the ultimate dynamic shear strength (S_{s,dynamic}) for each of the spot welds. The computer may determine the nominal normal stress (Sₙ) at a given load for each of the spot welds by dividing the applied normal load by the product of the weld diameter and the thickness of the smallest sheet meal used in forming the spot weld. The computer may further determine the ultimate dynamic normal strength (S_{n,dynamic}) of each of the spot welds. A second ratio may be determined by dividing the nominal normal stress (Sₙ) by the ultimate dynamic normal strength (S_{n,dynamic}) for each of the spot welds. A spot-weld value may be determined for each of the spot welds by a function of the first ratio and the second ratio and a spot-weld failure may be determined if the spot-weld value exceeds one (1).

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic representation of a methodology for analyzing a spot weld in accordance with the principles of the present disclosure;

FIG. 2 is a flowchart detailing the methodology of FIG. 1;

FIG. 3 is a plot of spot weld forces applied during a simulated vehicle impact event;

FIG. 4 is a plot of spot weld force rates applied during a simulated vehicle impact event;

FIG. 5 is a plot detailing a dynamic failure criteria for use in conjunction with the methodology of FIG. 1; and

FIG. 6 is a flowchart detailing use of the methodology during a simulated vehicle impact event.

### DETAILED DESCRIPTION

The following description of the preferred embodiment(s) is merely exemplary in nature and is in no way intended to limit the invention, its application, or uses.

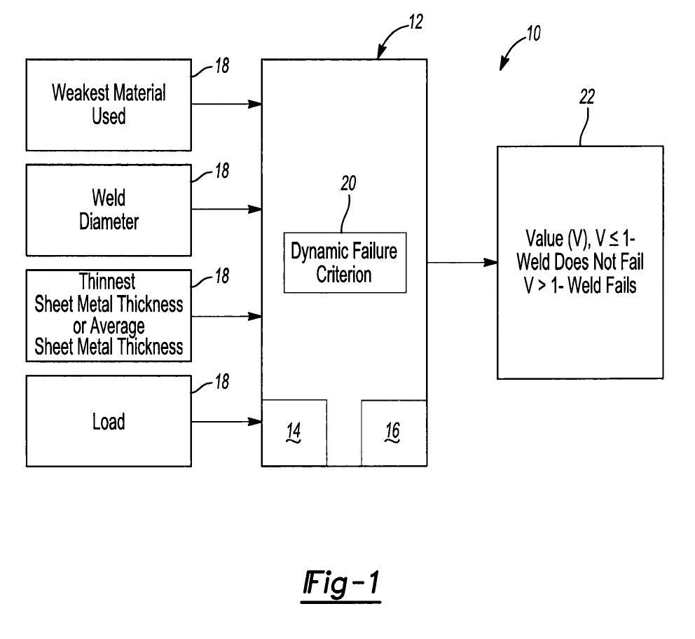

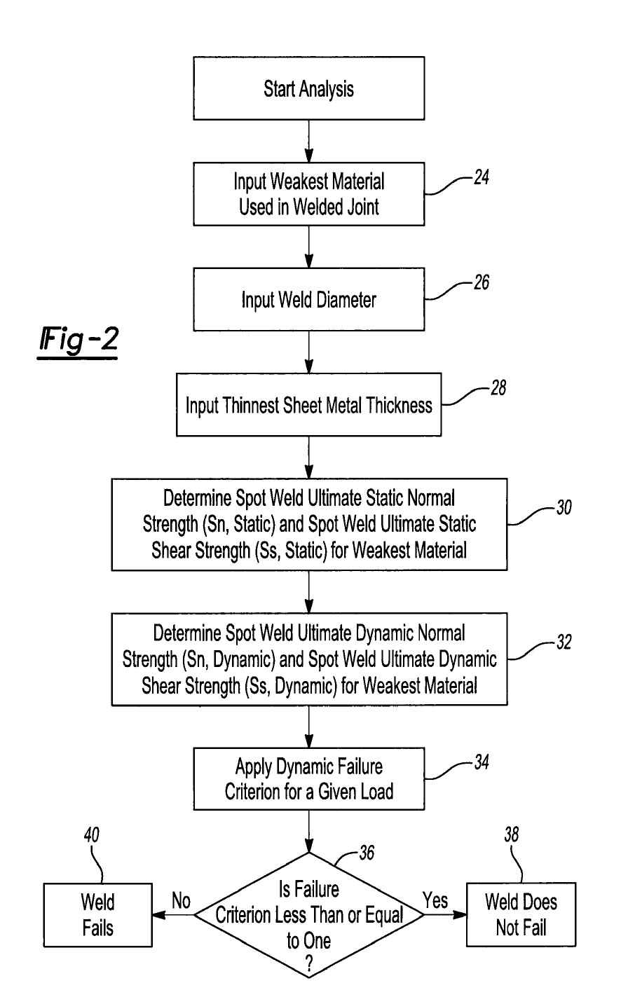

With particular reference to FIGS. 1 and 2, a methodology 10 for predicting failure of a spot weld is provided. The methodology 10 may be used during a simulated vehicle impact event to determine if and when spot welds of a simulated vehicle model (i.e., a virtual vehicle) fail during the simulated vehicle impact event. In one configuration, the methodology 10 may be executed by a computer 12 having a processor 14 and a memory 16. The methodology 10 may be stored in the memory 16 and may be performed by the processor 14 to analyze and determine whether a particular spot weld of the virtual vehicle fails during a simulated impact event.

The methodology 10 may be performed on each spot weld of a virtual vehicle model and may be performed at predetermined time intervals during a simulated vehicle impact event of the virtual vehicle model. In one configuration, the methodology 10 requires a series of four inputs 18 to determine whether a particular spot weld of the virtual vehicle model will fail during a simulated vehicle impact event. The four inputs 18 may include the weakest material used in forming a spot-welded joint, a weld diameter of a spot weld, the thinnest sheet metal thickness of two or more sheets used to form a spot-welded joint, and the load applied to the spot-welded joint. The inputs 18 may be received by the computer 12 and stored in the memory 16. The processor 14 may perform a dynamic failure criterion 20 and, based on the results of the dynamic failure criterion 20, may output a value at 22. Based on the particular value output by the dynamic failure criterion 20, the computer 12 will determine if and when (i.e., at what time interval) the particular spot weld of the virtual vehicle model will fail, as will be described in greater detail below.

With particular reference to FIG. 2, the methodology 10 performed by the computer 12 may include receiving information regarding the weakest material used in forming a welded joint at 24. The information received by the computer 12 may include the type of material as well as the ultimate strength (Sᵤₜ) of the particular material. Again, the foregoing material type and ultimate strength (Sᵤₜ) of the material are provided for the weakest material utilized in the welded joint.

In addition to receiving information regarding the weakest material used in a welded joint at 24, the computer 12 may also receive information regarding the diameter of a spot weld at 26 and may receive information regarding the thickness of the thinnest sheet metal utilized in forming the spot weld at 28. While the computer 12 is described as receiving information regarding the thickness of the thinnest sheet metal utilized in forming a spot-welded joint, the computer 12 could alternatively receive the thickness of each sheet utilized in forming the spot-welded joint and may compute an average thickness of the sheets for use by the processor 14 in evaluating the particular spot weld. While the processor 14 may utilize the thickness of the thinnest sheet metal utilized or an average of the thicknesses of each sheet utilized in forming a spot-welded joint, the processor 14 will be described hereinafter and shown in the drawings as utilizing the thickness of the thinnest sheet metal at step 28 in determining if and when a spot-welded joint will fail.

The weakest material used in the spot-welded joint, the diameter of the spot weld, and the thickness of the thinnest sheet metal utilized in forming the spot-welded joint may be manually input into the computer 12 at 24, 26, and 28, respectively. The foregoing three parameters can be manually input for each spot weld of a virtual vehicle model when the virtual vehicle model is constructed. While each of the foregoing three parameters may be manually input into the computer 12, the computer 12 could alternatively obtain the weakest material used in each spot-welded joint and the thickness of the thinnest sheet metal utilized in each spot-welded joint of a virtual vehicle model if the virtual vehicle model includes information regarding the type and thickness of each piece of sheet metal used when creating the virtual vehicle model. If the virtual vehicle model includes such information, the processor 14 may obtain the weakest material and thickness of each piece of sheet metal from the virtual vehicle model, thereby obviating the need to manually input the weakest material and thickness of the thinnest sheet metal for each spot-welded joint. Likewise, if the weld diameter for each spot weld of the virtual vehicle model is defined when the virtual vehicle model is created, the processor 14 can likewise obtain the weld diameter directly from the virtual vehicle model, thereby obviating the need to manually input the diameter of each spot weld.

Regardless of how (i.e., manually or directly from the virtual vehicle model) the processor 14 obtains the weakest material used for each spot-welded joint, the weld diameter of each spot-weld, and the thickness of the thinnest sheet metal utilized in each spot-welded joint, the processor 14 may determine the spot weld ultimate static normal strength (S_{n,static}) and spot weld ultimate static shear strength (S_{s,static}) for the weakest material at 30. Specifically, the processor 14 may determine the spot weld ultimate static normal strength (S_{n,static}) by utilizing Equation 1 below and may determine the spot weld ultimate static shear strength (S_{s,static}) by utilizing Equation 2 below.

$$\begin{matrix}{S}_{n , static} = {S}_{n , 2} = {S}_{n , 1} ( \frac{{S}_{ut , 2}}{{S}_{ut , 1}} ) & Equation 1 \\ {S}_{s , static} = {S}_{s , 2} = {S}_{s , 1} ( \frac{{S}_{ut , 2}}{{S}_{ut , 1}} ) & Equation 2\end{matrix}$$

In Equation 1, (S_{n,1}) and (S_{n,2}) are the spot weld ultimate static normal strength for a first material and a second material, respectively, while (S_{ut,1}) and (S_{ut,2}) are the ultimate tensile strength of the first material and the second material, respectively. Likewise, in Equation 2, (Sₛ₁) and (Sₛ₂) are the spot weld ultimate static shear strength for the first material and the second material, respectively, and (S_{ut,1}) and (S_{ut,2}) are the ultimate tensile strength of the first material and the second material, respectively. The spot weld ultimate static normal strength (S_{n,static}), spot weld ultimate static shear strength (S_{s,static}), and ultimate tensile strength (Sᵤₜ) may be determined based on static test data. For example, the spot weld ultimate static normal strength (S_{n,static}), spot weld ultimate static shear strength (S_{s,static}), and ultimate tensile strength (Sᵤₜ) can be determined based on static test data for a particular material and then can be utilized for different materials based on Equations 3 and 4 below.

$$\begin{matrix}\frac{{S}_{n 1}}{{S}_{ut , 1}} = \frac{{S}_{n 2}}{{S}_{ut , 2}} = {C}_{n} & Equation 3 \\ \frac{{S}_{s 1}}{{S}_{ut , 1}} = \frac{{S}_{s2}}{{S}_{ut , 2}} = {C}_{s} & Equation 4\end{matrix}$$

As indicated in Equations 3 and 4, the ratio of the spot weld ultimate static normal strength for a first material (S_{n,1}) to the ultimate strength of the first material (S_{ut,1}) is proportional to the ratio of the spot weld ultimate static normal strength for a second material (S_{n,2}) to the ultimate strength of the second material (S_{ut,2}). Therefore, the ratio of the spot weld ultimate static normal strength for the first material (S_{n,1}) to the ultimate strength of the first material (S_{ut,1}) and the ratio of the spot weld ultimate static normal strength of the second material (S_{n,2}) to the ultimate strength of the second material (S_{ut,2}) are equal and can be represented by a constant (Cₙ).

As with the spot weld ultimate static normal strength (Sₙ) of the first material and the second material, the ratio of the spot weld ultimate static shear strength of a first material (S_{s,1}) to the ultimate strength of the first material (S_{ut,1}) to the ratio of the spot weld ultimate static shear strength of a second material (S_{s,2}) to the ultimate strength of the second material (S_{ut,2}) are proportional. Therefore, the ratio of the spot weld ultimate static shear strength of the first material (S_{s,1}) to the ultimate strength of the first material (S_{ut,1}) and the ratio of the spot weld ultimate static shear strength of the second material (S_{s,2}) to the ultimate strength of the second material (S_{ut,2}) are equal and can be represented by a constant (Cₛ).

Based on Equations 3 and 4, static test data for a single material may be input into the computer 12. The processor 14 may utilize the static test data for the particular material in determining the spot weld ultimate static normal strength (S_{n,static}) and spot weld ultimate static shear strength (S_{s,static}) of a different material, based on the relationships set forth in Equations 3 and 4. Static test data for each material utilized in the virtual vehicle model—including spot weld ultimate static normal strength (S_{n,static}), spot weld ultimate static shear strength (S_{s,static}), and ultimate tensile strength (Sᵤₜ)—is not required by the processor 14. Rather, the processor 14 can rely on the ratios set forth in Equations 3 and 4 in determining the spot weld ultimate static normal strength (S_{n,static}) and the spot weld ultimate static shear strength (S_{s,static}) for a spot-welded joint having at least two dissimilar materials.

Once the spot weld ultimate static normal strength (S_{n,static}) and spot weld ultimate static shear strength (S_{s,static}) are determined using Equations 1 and 2 above, the processor 14 may determine the spot weld ultimate dynamic normal strength (S_{n,dynamic}) and spot weld ultimate dynamic shear strength (S_{s,dynamic}) for the weakest material of a spot-welded joint at 32. Specifically, the processor 14 may determine the spot weld ultimate dynamic normal strength (S_{n,dynamic}) utilizing the relationship shown in Equation 5 and may determine the spot weld ultimate dynamic shear strength (S_{s,dynamic}) utilizing the relationship set forth in Equation 6.

$$\begin{matrix}{S}_{n , dynamic} = {S}_{n , static} [ 1.183 + 0.002963 \times ( \frac{\dot{P}}{0.1} ) + 0.0458 \times log ( \frac{\dot{P}}{0.1} ) ] & Equation 5 \\ {S}_{s , dynamic} = {S}_{s , static} [ 1.183 + 0.002963 \times ( \frac{\dot{P}}{0.1} ) + 0.0458 \times log ( \frac{\dot{P}}{0.1} ) ] & Equation 6\end{matrix}$$

As shown in Equations 5 and 6, the spot weld ultimate static normal strength (S_{n,static}) determined in Equation 1 is utilized in Equation 5, while the spot weld ultimate static shear strength (S_{s,static}) determined in Equation 2 is utilized in Equation 6. Other than the spot weld ultimate static normal strength (S_{n,static}) and spot weld ultimate static shear strength (S_{s,static}), the only other input required by Equations 5 and 6 is the load rate \dot{P}, which is defined as the change in load divided by the change in time.

The spot weld ultimate dynamic normal strength (S_{n,dynamic}) and spot weld ultimate dynamic shear strength (S_{s,dynamic}) may be utilized by the processor 14 when performing the dynamic failure criterion 20 (FIG. 1) at 34. The failure criterion 20 may be defined by the relationship shown below in Equation 7.

$${( \frac{{S}_{s}}{{S}_{s , dynamic}} )}^{β} + {( \frac{{S}_{n}}{{S}_{n , dynamic}} )}^{β} \leq 1 \qquad Equation 7$$

In Equation 7, the spot weld ultimate dynamic normal strength (S_{n,dynamic}) and spot weld ultimate dynamic shear strength (S_{s,dynamic}) determined in Equations 5 and 6, respectively, are utilized by Equation 7 to determine if and when a particular spot weld will fail under a given load. The nominal shear stress (Sₛ) and nominal normal stress (Sₙ) may be determined by Equations 8 and 9, respectively, where Pₙ is the spot weld normal stress, Pₛ is the spot weld shear stress, D is the weld diameter, and t is the thickness of the thinnest sheet metal utilized in the spot-welded joint.

$$\begin{matrix}{S}_{n} = \frac{{P}_{n}}{D \cdot t} & Equation 8 \\ {S}_{s} = \frac{P}{D \cdot t} & Equation 9\end{matrix}$$

The exponent data (δ) may be determined experimentally by subjecting a spot weld to loads at various angles and generating a failure curve/surface. The failure curve/surface may be plotted on a relationship of the applied nominal normal stress (Sₙ) versus the applied nominal shear stress (Sₛ), whereby the exponent (δ) is defined by the shape of the failure curve/surface. The exponent (δ) is a value generally between one (1) and two (2), as an exponent (δ) equal to one (1) would result in a failure curve being substantially straight while an exponent (δ) having a value of two (2) would result in a failure curve forming one-quarter of a circle. Providing the exponent term with a value between one (1) and two (2) provides the shape of the failure curve somewhere between a straight line and a curve representing one-quarter of a circle.

Once the processor 14 determines the nominal normal stress (Sₙ) and nominal shear stress (Sₛ), the processor 14 may perform the dynamic failure criterion 20 by utilizing the relationship set forth in Equation 7. Applying the relationship set forth in Equation 7 allows the processor 14 to determine whether a particular spot weld will fail at 36. If the value (V) output by Equation 7, for example, is less than or equal to one (1), the processor 14 determines that the weld does not fail at 38. If, on the other hand, the value determined by the processor 14 utilizing Equation 7 is not less than or equal to one (1), the processor 14 determines that the weld fails at 40.

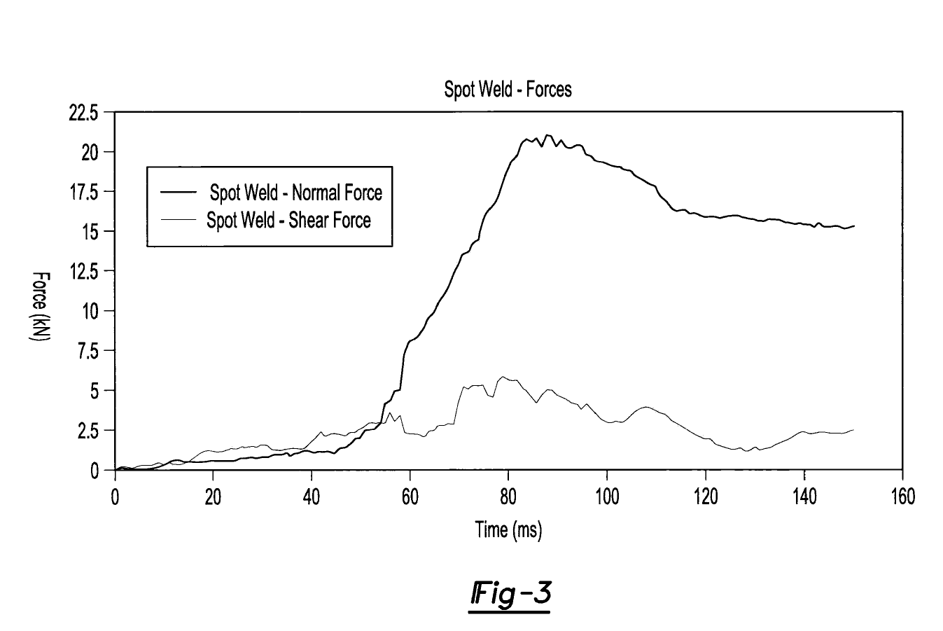

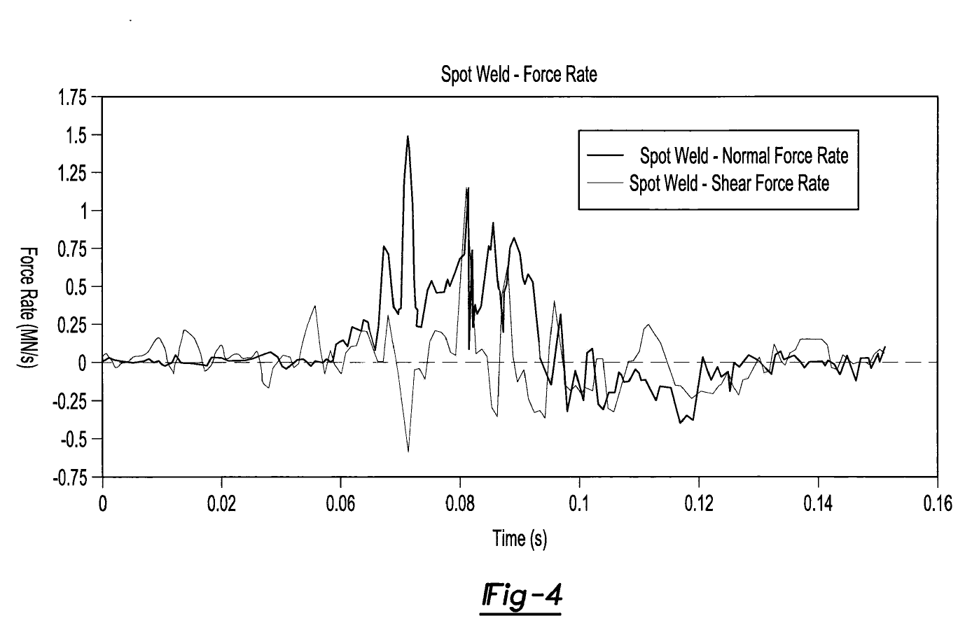

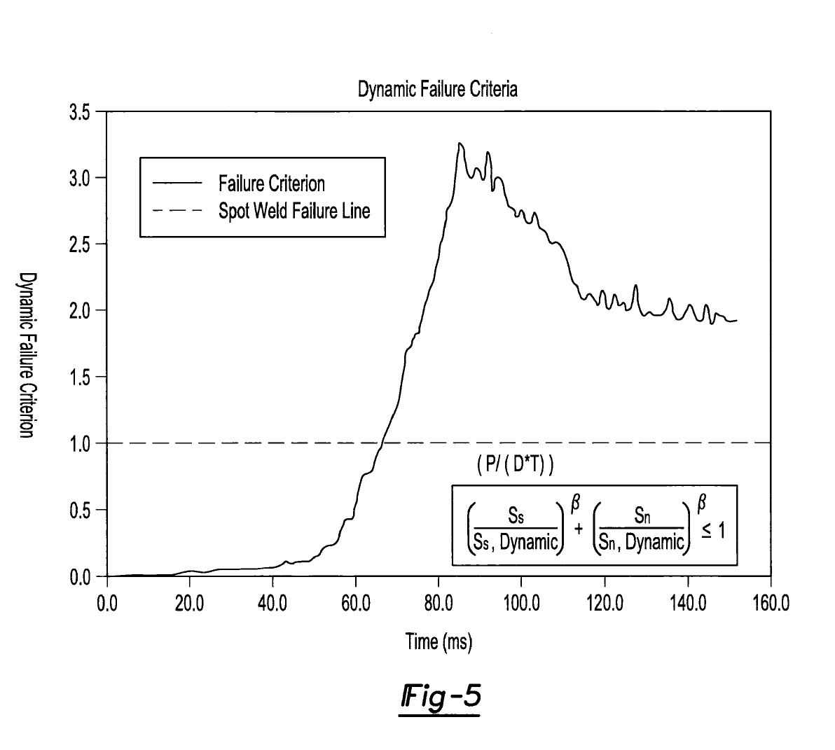

While the foregoing Equations 1-9 provide the basis for the processor 14 in determining whether a spot weld will fail and, if so, when the spot weld will fail, FIGS. 3-5 provide a graphical representation of spot weld forces applied to a spot weld over time (FIG. 3), the rate of the applied force over time (FIG. 4), as well as a graphical representation of the dynamic failure criterion 20 (FIG. 5). As shown in FIG. 5, the processor 14 may repeatedly perform the Equations 1-9 to determine whether a spot weld will fail at predetermined time intervals. For example, the processor 14 may continually perform Equations 1-9 and, once the output of Equation 7 exceeds one (1) (FIG. 5), the processor 14 can note the time of the failure and may remove the weld from the virtual vehicle model.

An exemplary curve is shown in FIG. 5, whereby the exemplary spot weld is shown to fail at some point between sixty milliseconds and eighty milliseconds. As will be described in greater detail below, once the processor 14 determines if and when a weld fails, the processor 14 removes the weld from the virtual vehicle model and continues to perform Equations 1-9 on the remaining spot welds of the virtual vehicle model. Removing failed spot welds distributes the remaining forces applied to the virtual vehicle model, thereby requiring the remaining spot welds to absorb the applied forces and therefore provides a simulated vehicle impact event that correlates well with an actual vehicle test.

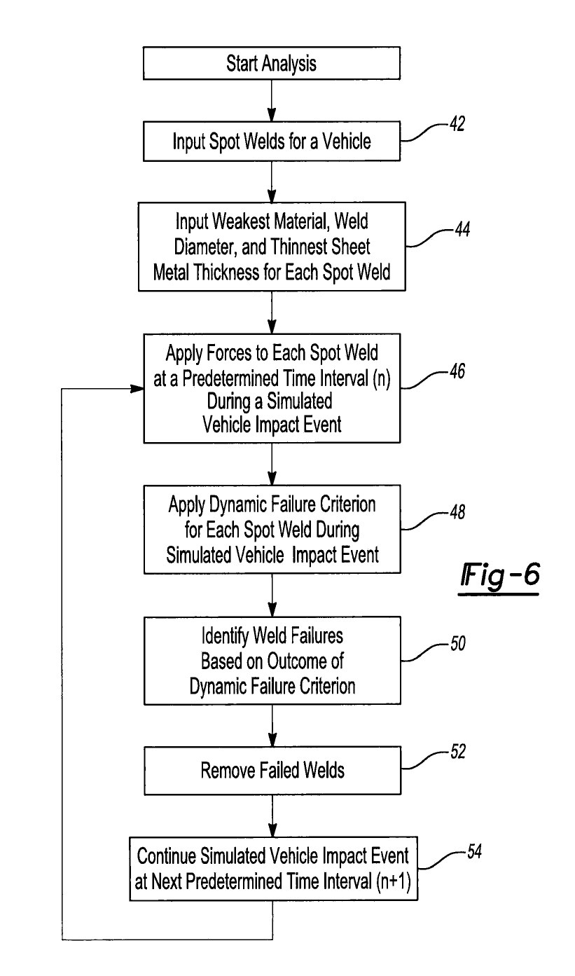

With particular reference to FIG. 6, a flowchart detailing operation of the methodology 10 in conjunction with a simulated vehicle impact event is provided. At the outset, each spot weld of a virtual vehicle model may be stored in a memory 16 of the computer 12 at 42. Identification of each spot weld and its location within the virtual vehicle model allows the computer 12 to perform the methodology 10 on each spot weld at predetermined time intervals during a simulated vehicle impact event.

As described above, the methodology 10 may require input of the weakest material used in forming each spot weld, the weld diameter of each spot weld, and the thickness of the thinnest sheet metal used in forming each spot weld. The foregoing inputs may be provided to the memory 16 of the computer 12 at 44. While the foregoing inputs may be provided to the computer 12 by way of manually inputting each input, the foregoing inputs could alternatively be retrieved by the computer 12 from the virtual vehicle model, as described above.

Once each spot weld of the virtual vehicle is identified and the parameters set forth at step 44 are provided to the computer 12, the computer 12 may begin a simulated vehicle impact event. Specifically, the processor 14 may apply simulated forces to each spot weld of the virtual vehicle model at predetermined time intervals (n) during the simulated vehicle impact event at 46. During the simulated vehicle impact event, the processor 14 may apply the dynamic failure criterion 20 to each spot weld at each predetermined time interval (n) at 48.

As described above, applying the dynamic failure criterion 20 to each spot weld allows the dynamic failure criterion 20 to identify failed welds if the result of the dynamic failure criterion 20 exceeds one (1). Therefore, the processor 14 may utilize the dynamic failure criterion 20 to identify spot weld failures at 50 and may remove failed welds from the virtual vehicle model at 52. The processor 14 may continue the simulated vehicle impact event at the next predetermined time interval (n+1) at 54 following removal of the failed welds. The processor 14 may continue to perform the methodology 10 on each spot weld at each predetermined time interval (n) and may continue to remove failed welds in an effort to provide a simulated vehicle impact event that correlates well with an actual impact event.

Removing the failed welds allows the simulated vehicle impact event to correlate well with an actual vehicle test, as removing failed welds allows the forces applied at 46 to be transferred to other neighboring spot-welded joints or other load-bearing elements/components of the virtual vehicle model. The virtual vehicle model can then be compared to an actual vehicle test by comparing the performance of each spot-welded joint at each predetermined time interval (n) of the virtual vehicle model. If the simulated vehicle impact event correlates well with an actual vehicle test, a particular spot weld should fail at approximately the same time interval (n) in both the simulated vehicle impact event and in the actual vehicle test. Namely, the result of the dynamic failure criterion 20 should exceed one (1) within the same predetermined time interval (n) that the spot weld fails in the actual vehicle test.

For example, as shown in FIG. 5, the spot-welded joint under test in FIG. 5 fails (i.e., the dynamic failure criterion 20 exceeds one (1)) at some point between sixty milliseconds and eighty milliseconds. If an actual vehicle test were performed, the simulated impact event would correlate well with the actual vehicle test if the same spot weld of the actual vehicle fails at approximately the same time (i.e., at some point between sixty milliseconds and eighty milliseconds in the example shown in FIG. 5).

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method comprising:
generating by a computer a virtual vehicle model;
providing said vehicle model with spot-welds;
providing data regarding said spot-welds;
applying forces by said computer to said spot welds during a simulated impact event of said vehicle model;
analyzing by said computer each of said spot welds at predetermined time intervals during said simulated impact event;
identifying by said computer failed spot welds based on said analyzing;
removing by said computer failed spot welds from said vehicle model; and
continuing to apply said forces by said computer to said spot-welds following removal of said failed spot welds.

2. The method of claim 1, wherein providing said data includes providing a location of each of said spot welds within said vehicle model.

3. The method of claim 1, wherein providing said data includes identifying the weakest material used in each of said spot welds, a diameter of each of said spot welds, and one of a thickness of the thinnest sheet metal used in each of said sport welds or an average thickness of all sheet metals used in each of said spot welds.

4. The method of claim 1, wherein analyzing said spot welds includes applying a failure criterion to each of said spot welds at said predetermined time intervals.

5. The method of claim 4, wherein applying said failure criterion includes determining a first ratio of nominal shear stress (Sₛ) and spot weld ultimate dynamic shear strength (S_{s,dynamic}) and a second ratio of nominal normal stress (Sₙ) and spot weld ultimate dynamic normal strength (S_{n,dynamic}).

6. The method of claim 5, wherein applying said failure criterion includes adding said first ratio to said second ratio to determine a spot-weld value.

7. The method of claim 6, wherein identifying said failed spot welds includes identifying spot welds that have a spot-weld value that exceeds one (1).

8. The method of claim 6, wherein said removing said failed spot welds includes removing spot welds having a spot-weld value that exceeds one (1).

9. The method of claim 1, wherein said analyzing each of said spot welds includes determining by said computer the ultimate static shear strength (S_{s,static}) of each of said spot welds and the ultimate static normal strength (S_{n,static}) of each of said spot welds.

10. The method of claim 1, wherein said analyzing each of said spot welds includes determining by said computer the ultimate dynamic shear strength (S_{s,dynamic}) of each of said spot welds and the ultimate dynamic normal strength (S_{n,dynamic}) of each of said spot welds.

11. A method comprising:
generating by a computer a virtual vehicle model;
providing said vehicle model with spot welds;
determining by said computer the nominal shear stress (Sₛ) at a given load for each of said spot welds;
determining by said computer the ultimate dynamic shear strength (S_{s,dynamic}) of each of said spot welds;
determining a first ratio by dividing said nominal shear stress (Sₛ) by said ultimate dynamic shear strength (S_{s,dynamic}) for each of said spot welds;
determining by said computer the nominal normal stress (Sₙ) at a given load for each of said spot welds;
determining by said computer the ultimate dynamic normal strength (S_{n,dynamic}) of each of said spot welds;
determining a second ratio by dividing said nominal normal stress (Sₙ) by said ultimate dynamic normal strength (S_{n,dynamic}) for each of said spot welds;
determining a spot-weld value for each of said spot welds by adding said first ratio and said second ratio; and
determining a spot-weld failure if said spot-weld value exceeds one (1).

11. The method of claim 10, wherein determining said nominal shear stress (Sₛ) includes dividing the spot weld shear stress (Pₛ) by the product of the spot-weld diameter (D) and the spot-weld thickness (t).

12. The method of claim 11, wherein said spot-weld thickness (t) is determined based on the thickness of the thinnest sheet metal used in said spot weld.

13. The method of claim 11, wherein said spot-weld thickness (t) is determined based on an average thickness of all sheet metals used in said spot weld.

14. The method of claim 10, wherein determining said nominal normal stress (Sₙ) includes dividing the spot weld normal stress (Pₙ) by the product of the spot-weld diameter (D) and the spot-weld thickness (t).

15. The method of claim 14, wherein said spot-weld thickness (t) is determined based on the thickness of the thinnest sheet metal used in said spot weld.

16. The method of claim 14, wherein said spot-weld thickness (t) is determined based on an average thickness of all sheet metals used in said spot weld.

17. The method of claim 10, further comprising applying a load by said computer to each of said spot welds at predetermined time intervals.

18. The method of claim 17, further comprising determining by said computer said spot-weld value at each of said time intervals.

19. The method of claim 18, further comprising removing by said computer failed spot welds from said vehicle model.

20. The method of claim 19, further comprising continuing to apply said load on remaining ones of said spot welds following removal of said failed spot welds.
